(19) United States
(12) Patent Application Publication
(10) Pub. No.: US 2008/0015884 A1
(43) Pub. Date: Jan. 17, 2008

(54) OPERATION AWARENESS SYSTEM

(75) Inventor: Gerald J. Jamula, New Boston, MI (US)

Correspondence Address: KNOBBE MARTENS OLSON & BEAR LLP, 2040 MAIN STREET, FOURTEENTH FLOOR, IRVINE, CA, 92614, US

(73) Assignee: United States Postal Service

(21) Appl. No.: 11/777,803

(22) Filed: Jul. 13, 2007

Related U.S. Application Data
(60) Provisional application No. 60/830,863, filed on Jul. 14, 2006.

(51) Int. Cl. G06Q 10/00

(52) U.S. Cl. 705/1

(57) ABSTRACT

Systems and methods of providing operational information in a first shipping facility at a first location which receives items from at least one second shipping facility which is at a second location. One embodiment is a method which includes collecting facility processing data representative of activities at the first shipping facility, collecting shipping data representative of activities at least one second shipping facility, the data based on items being shipped from the at least one second shipping facility to the first shipping facility, determining operational information from the facility processing data and the shipping data, the operational information relating to at least one aspect of processing items received at the first shipping facility, communicating at least a portion of the operational information to a wireless device at the first shipping facility, and displaying the operational information communicated to the wireless device on a user interface of the wireless device.

### RELATED APPLICATIONS

The Application for Patent claims priority to Provisional Application No. 60/830,863 entitled “OPERATION AWARENESS SYSTEM” filed Jul. 14, 2006, which is assigned to the assignee hereof and hereby expressly incorporated by reference herein.

### BACKGROUND

1. Field of the Invention

The field of the invention relates to providing operational data to mobile devices for managing equipment and personnel resource in a distribution or shipping facility.

2. Description of the Related Technology

Commercial shipping activities require tracking and distributing a large number of items to numerous geographical locations. To effectively perform these activities also requires monitoring resources used in the activities, i.e., the sorting, tracking and shipping equipment, and the human resources that operate the equipment. Shipping activities can have multiple processing facilities that serve as routing points through which the items pass through on the way to their next, or final, destination. Typically, a processing facilities receives items from one of the other facilities, sorts, monitors and/or tracks the items, and then routes some or all of the items to other processing facilities for further distribution and/or processing, or ships the items to their final destination. Some shipping activities process literally millions of items each day. Effectively shipping such a large number of items involves determining the best way to utilize resources and depending on changing day-to-day operational needs.

In one example of a shipping activity, the U.S. Postal Service® has developed data collection flows that gather and store data related to the processing of billions of pieces of mail that flow through their mail processing plants across the United States. Certain data related to shipping and processing items can be collected by monitoring activities over the course of a day and then stored into a data repository. Shipping and processing reports may be generated using data stored in the repository, and these “historical” reports can be stored on a network computer system for the supervisors to call up from their desktop workstations. Analysis of the collected data facilitates managing the workforce, monitoring the mail processing equipment, and estimating the number of items that will need to be processed during a given time period in the future.

Typically, consolidated reports showing shipping estimates and facility resources are not available to supervisors until at least the end of a sorting run or the end of the day, and sometimes later. Accordingly, planning and decisions are made based on historical trends and estimates instead of actual real-time or near real-time data. For example, a supervisor for a processing operation may know that Fridays are normally heavy shipping days, a certain percentage of their work force may take leave or be sick on a particular day, and the processing equipment has a certain average mean time to failure, all of which the supervisor takes into account when estimating the number of employees (full time, temps, and seasonal) to have on site for a given workday. Due to the uncertainties resulting from making decisions based on day old and/or older historical data, often the supervisor will have too many or too few employees available to perform the job done efficiently.

Effectively managing a shipping or processing facility that may handle hundreds of thousands (or more) items a day is a dynamic task involving direct contact with ongoing operation. Much of the supervisor's time is typically spent “on the floor” overseeing ongoing operations. Instead of sitting at his or her desk reviewing reports on yesterday's shipping and processing activities, a supervisor's typical routine is to follow the flow of the items being processed, ensure that personnel are at their stations working safely, and assist maintenance personnel with resolving equipment failures. A supervisor may also oversee unloading operations of trucks bringing items to his facility and estimate the incoming volume of items as trucks unload items. While inter-facility shipping is one example of such an activity, intra-facility shipping (e.g., sending items from a first location in a large facility to a second location in the large facility) also benefits from monitoring the movement of items to determine the equipment and manpower required to process such items arriving at the second location.

To effectively manage and make informed decisions for such processing operations, a supervisor would benefit from improvements in technology that provide accurate shipping and processing operational data delivered in real-time or near real-time. Improvements on collecting, processing and providing such data can allow the operations of a processing facility to run more efficiently, which would benefit customers of the service by having their items delivered cheaper and faster.

### SUMMARY OF CERTAIN EMBODIMENTS

The systems and methods described in this disclosure each may have several features, no single one of which is solely responsible for its desirable attributes. Without limiting the scope of this disclosure, its more prominent features will now be discussed briefly. After considering this discussion, and particularly after reading the section entitled “Detailed Description of Certain Inventive Aspects” one will understand how the features of these systems and methods provide advantages over monitoring systems.

In one embodiment, a method of providing operational information in a first shipping facility at a first location, the first shipping facility receiving items from at least one second shipping facility which is at another location, includes collecting facility processing data representative of a first plurality of metrics produced in association with the first shipping facility, wherein the first plurality of metrics includes information related to equipment resources and personnel resources, collecting shipping data representative of a second plurality of metrics that include information related to items that are being shipped to the first shipping facility from the at least one second shipping facility, determining operational information based on the facility processing data and the shipping data, wherein the operational information relates to the processing of items received at the first shipping facility from the at least one second shipping facility, storing the operational information, communicating at least a portion of the operational information to a wireless device at the first shipping facility, and displaying the operational information communicated to the wireless device on a user interface of the wireless device.

The shipping data can comprise the number of items that are being shipped from the at least one second shipping facility to the first shipping facility. The items can include mail, packages, or goods. In some aspects, collecting facility processing data comprises collecting data from processing equipment that sorts the items being shipped. Collecting facility processing data can include collecting employee data. In some aspects, determining operational information from the shipping data includes applying a predetermined factor to at least a portion of the shipping data to determine the operational data. The predetermined factor can be a service standard for shipping items from at least one of the second shipping facilities to the first shipping facility. In some aspects, collecting shipping data includes receiving shipping data representative of the second plurality of metrics at the first shipping facility and the at least one second facility, the second plurality of metrics including the number of items to be shipped to each of the other shipping facilities on a specified day. In some examples, the specified day is the current day, or the next day.

Determining operational information from the shipping data can include using a service standard to generate an expected arrival date for items being shipped to the first shipping facility. Displaying the operational information can comprise displaying an expected cumulative incoming number of items to the first shipping facility for the current day and at least one day subsequent to the current day. In some instances, displaying operational information comprises displaying an expected cumulative incoming number of items to arriving at the first shipping facility for the current day and at least one day subsequent to the current day. The operational information is periodically communicated to the wireless device, and this period can be either a predetermined period, or a selected period by the user (e.g., selected to minimize power consumption). The setting can be, for example, on minute five minutes, or longer. In some aspects, collecting facility processing data comprises collecting data from one or more piece of processing equipment located at the first shipping location. Displaying operational information can include displaying at least one of following: equipment failures, equipment emergency stops, number of equipment jams, number of items rejected by the processing equipment, and throughput volume of the equipment. Collecting facility processing data can include collecting employee workforce data. The employee workforce data can include at least one of the following: count of workers allocated to one or more operations, hours in operation for the one or more operations, and overtime hours for the one or more operations. In some aspects, displaying the operational information includes displaying at least one of the count of workers allocated to one or more operations, hours in operation for the one or more operations, and overtime hours for the one or more operations. The user interface includes one or more selectable display screens for displaying operational information.

In another embodiment, a system configured to provide information in a first shipping facility at a first location for managing operations at the first shipping facility, the first shipping facility receiving items from at least one second shipping facility which is in another location, includes a data collection system configured to collect facility processing data representative of a first plurality of metrics produced in association with the first shipping facility, wherein the first plurality of metrics includes information related to equipment resources and personnel resources for processing items at the first shipping facility, the data collection system being further configured to collect shipping data representative of a second plurality of metrics, wherein the second plurality of metrics includes information related to items that are being shipped to the first shipping facility from the at least one second shipping facility, an operational information system configured to determine operational information based on the facility processing data and the shipping data collected by the data collection, wherein the operational information relates to processing items received at the first shipping facility from the one or more second shipping facilities, and further configured to provide operational information to the first shipping facility, a communication system located at the first shipping facility for receiving operational information, and further configured to communicate at least a portion of the operational information to a wireless device, and a wireless device configured to receive the operational information from the operational information system, wherein the wireless device comprises a display, and wherein the wireless device further comprises a user interface configured to control the display of the operational information.

In some aspects, the user interface comprises a display screen to display an expected cumulative incoming item volume for the current day and at least one day subsequent to the current day at the first location. The user interface can comprise a display screen to display an expected cumulative incoming item volume for the current day and three days subsequent to the current day. In some aspects, the operational information system is configured to receive a request for operational information from the wireless device and provide operational information to the wireless device based on the request, and wherein the user interface is configured to receive as input a request for operational information, and wherein the wireless device is configured to communicate the request for operational information to the operational information system.

In another embodiment, a system configured to provide timely information in a first shipping facility at a first location for managing operations at the first shipping facility, the first shipping facility receiving items from at least one second shipping facility at another location, includes means for collecting facility processing data representative of a first plurality of metrics collected from the first shipping facility, wherein the first plurality of metrics includes information related to equipment resources and personnel resources for processing items at the first shipping facility, means for collecting shipping data representative of a second plurality of metrics from the at least one second shipping facility, wherein the second plurality of metrics includes information related to items that are being shipped to the first shipping facility from the at least one second shipping facility, means for determining operational information based on the facility processing data and the shipping data, wherein the operational information relates to processing items received at the first shipping facility from the at least one second shipping facilities, means for storing the operational information at the first shipping facility, means for communicating at least a portion of the operational information to a wireless device at the first shipping facility, and means for displaying the operational information communicated to the wireless device on a user interface of the wireless device.

In another embodiment, a machine readable medium includes instructions for providing operational information in a first shipping facility which is at a first location and which receives items from at least one second shipping facility which is at a second location, that upon execution cause a machine to collect facility processing data representative of a first plurality of metrics collected from the first shipping facility, wherein the first plurality of metrics includes information related to equipment resources and personnel resources for processing items at the first shipping facility, collect shipping data representative of a second plurality of metrics from the at least one second shipping facility, wherein the second plurality of metrics includes information related to items that are being shipped from the at least one second shipping facility to the first shipping facility, determine operational information based on the facility processing data and the shipping data, wherein the operational information relates to processing items received at the first shipping facility from the at least one second shipping facility, store the operational information at the first shipping facility, communicate at least a portion of the operational information to a wireless device at the first shipping facility, and display the operational information communicated to the wireless device on a user interface of the wireless device.

### BRIEF DESCRIPTION OF THE DRAWINGS

FIG. 1 is a block diagram illustrating a system for providing information to process items received at a first location from one or more second locations.

FIG. 2 is a block diagram illustrating an example of one embodiment of the system illustrated in FIG. 1.

FIG. 3 is a diagram of a mobile device illustrating a user interface screen for displaying the count of incoming items from a plurality of locations.

FIG. 4 is a diagram of a mobile device illustrating a user interface screen for displaying the status of a particular piece of processing equipment.

FIG. 5 is a diagram of a mobile device illustrating a user interface screen for displaying workforce information for three processing operations.

FIG. 6 is a flowchart illustrating a process of providing information to process and items received at a first location from one or more second locations.

### DETAILED DESCRIPTION OF CERTAIN INVENTIVE ASPECTS

Although the following detailed description is directed to certain embodiments of the invention, the invention can be embodied in a multitude of different ways. The appearances of the phrase “in one embodiment,” “according to one embodiment,” or “in some embodiments,” or the like, in various places in the specification means that a particular feature, structure, or characteristic described in connection with the embodiment is included in at least one embodiment, but are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The following description also includes details of certain embodiments and examples. However, it is understood by one of ordinary skill in the art that the examples may be practiced even if every detail of a method or system in an example or embodiment is not described or illustrated herein. For example, computer-based systems may be shown in block diagrams that do not illustrate every electrical connection, every communication line, or every element of the system in order not to obscure the examples in unnecessary detail.

Those of ordinary skill in the art will further appreciate that the various illustrative components, systems, modules and algorithm steps described in connection with the examples disclosed herein may be implemented as electronic hardware, firmware, computer software, middleware, microcode, or combinations thereof. To clearly illustrate this interchangeability of hardware and software, various illustrative components, blocks, modules, circuits, and steps have been described above generally in terms of their functionality. Such functionality can be implemented as hardware or software, and may depend on the particular application and design constraints imposed on the overall system. Also, functionality (e.g., as embodied in software) described in some embodiments herein as being in a particular location or on particular computer can, in other embodiments, be in another location or on another computer in other embodiments. Skilled artisans may implement the described functionality in varying ways for each particular application, but such implementation decisions should not be interpreted as causing a departure from the scope of the disclosed methods.

Every day millions of items (e.g., packages, goods, and mail) are sent from one location to another by a variety of private, government and commercial entities. Often the items travel through one or more shipping or processing facilities as the items are routed from their shipping or mailing point of origin to their final destination at a residence, post office box, or commercial facility. Effectively managing such shipping or processing facilities that may handle hundreds of thousands (or more) items in a day typically requires direct involvement of supervisory personnel with ongoing operations to follow the flow of the items being processed, ensure that personnel are at their station working safely, and assist maintenance personnel with equipment failures.

A status system, as described herein, can provide supervisors of such facilities with up-to-date information relating to day-to-day operational requirements of a facility, a status system can be configured to deliver real-time (or near real-time) information on a mobile device carried by the supervisor. The status system collects shipping data (e.g., data relating to the items that are to be shipped from one facility to another facility) and processing facility data (e.g., data related to the equipment and personnel resources at a particular facility) from databases at each facility, and communicates a certain portion of the collected data to a particular processing facility to that facility.

The databases used to store data collected by the status system can be databases existing at the processing facility that are appropriately modified to store shipping data and processing facility data, or new databases can be installed on appropriate computer systems. In some facilities, part or all of the data the status system collects may already be collected but not used not to manage the real-time or near real-time operations at the other associated facilities that will be impacted by the receipt of items from the facility generating the data (e.g., processing facility data). The shipping data collected from one facility that pertains to another particular facility (e.g., number of incoming items) is communicated to the receiving facility and made available to a supervisor in an easily understandable format via a wireless transmission system displayed on a portable computer device carried by a supervisor. Because equipment and employee data are facility specific, a supervisor receives the equipment data and employee data related to the facility where he works. The actual data presented to a supervisor can be customized based on the supervisor's preferences and operational needs.

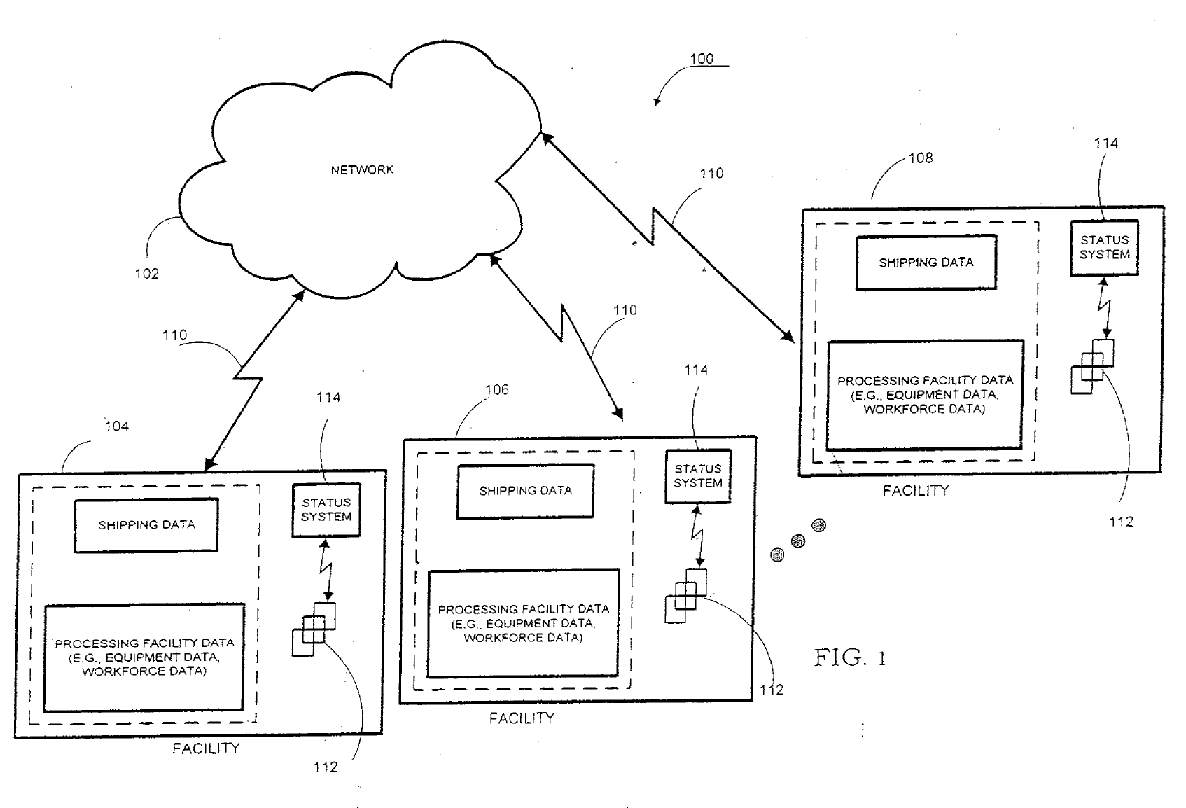

FIG. 1 is a block diagram illustrating a shipping system 100 that includes processing facilities 104, 106, 108 at different geographical locations. The processing facilities 104, 106, 108 ship and route items (e.g., packages, mail, goods) from an originating point to a final destination. The originating point can be, for example, one of the processing facilities 104, 106, 108. The originating point can also be a pick-up location, including a residence, commercial facility, or a drop-off box (e.g., a mail box). After pick-up, the items are taken to one of the processing facilities 104, 106, 108 for routing and shipping to their final destination. The processing facilities 104, 106, 108 each include a status system 114 that can track, store and provide data relating to the shipped items. Typically the status system 114 for a processing facility is physically located at the processing facility. However, in some embodiments, the status system 114 is not co-located with the processing facility; in such cases the status system 114 is in communication with the equipment and systems at the processing facility that it supports such that it can track, store, and provide data relating to the processing facility. The status system 114 can also track, store and provide data relating to personnel and operations of the processing facilities 104, 106, 108. As referred to herein, “item” is a broad term, and it refers to things that are shipped from one location to another (for example, goods, packages, mail, parcels, overnight letters and packages) and is sometimes generally referred to herein as “mail.”

The system 100 shown in FIG. 1 includes a communication network 102 and connections 110 that connect each of the processing facilities 104, 106, 108 to the network 102. The system 100 and network are configured to allow data communication between the processing facilities 104, 106, 108. The network 102 can be one network, or a plurality of smaller networks connected to form network 102. The network 102 can include wired or wireless networks. The network can 102 can include, but is not limited to, one or more of the following networks: the Internet, intranets, local area networks (LAN), wide area networks (WAN), or other suitable networks. In addition, the connectivity to the network 102 may be, for example, remote modem, Ethernet, token ring, fiber distributed datalink interface (FDDI), asynchronous transfer mode (ATM), wireless Ethernet, or Bluetooth.

The day-to-day operations of each of the processing facilities 104, 106, 108 includes processing items originating from each individual facility and processing items incoming from one or more other processing facilities. Each of the processing facilities 104, 106, 108 uses a variety of automatic and/or semi-automatic sorting, tracking and shipping equipment to sort, track and route items to their final destination. The equipment is run by a workforce that is (ideally) sized to handle the daily incoming items. Preferably, the workforce of a particular processing facility is sized to handle the amount of items being shipped from/to that facility without creating a backlog of items to be processed or having excessive personnel who may not be fully and efficiently utilized.

The processing equipment at each of the processing facilities 104, 106, 108 sorts and tracks the incoming and/or outgoing items processed at that location. The destination of each item is electronically collected for each item as the incoming items are processed by the sorting equipment, and this “shipping data” is collected on the status system 114 at each facility. “Shipping data” refers to data collected from processing and sorting the items that are being shipped. For example, shipping data can include the number of items being shipped and the destination of each item (e.g., city, state, or zip code). Shipping data can also include, or represent data, or metrics, that are derived from any data collected while processing or sorting individual items (e.g., data related to each individual item). For example, shipping data comprises the destination of where each item is being shipped. Shipping data can also comprise the total number of items being shipped to each location, or other metrics derived from the individual item data. In this way the shipping data can represent one or more metrics related to the items being processed by a shipping facility. Although historical trends and statistics may generally predict the expected incoming volume of items, having real-time or near real-time shipping data is extremely beneficial for a supervisor who is tasked with efficiently supervising a processing facility.

Periodically, operational information relating to shipping data is communicated from the status system 114 of one facility via connections 110 and the network 102 to the status system 114 at the one or more second facilities, where it is stored by the status system 114 at the second facility for further use by a supervisor at the second facility. The status system 114 is configured to (ultimately) provide real-time or near real-time operational information relating to shipping data of items being shipped from that facility to a supervisor at a receiving facility before the shipment of items arrive. The supervisor receiving the information can use the operational information for planning operations, allocating equipment, and allocating and personnel resources, at his facility. For example, the status system 114 at one facility consolidates inputs from other processing facilities to provide the cumulative number of incoming items shipped from the other processing facilities.

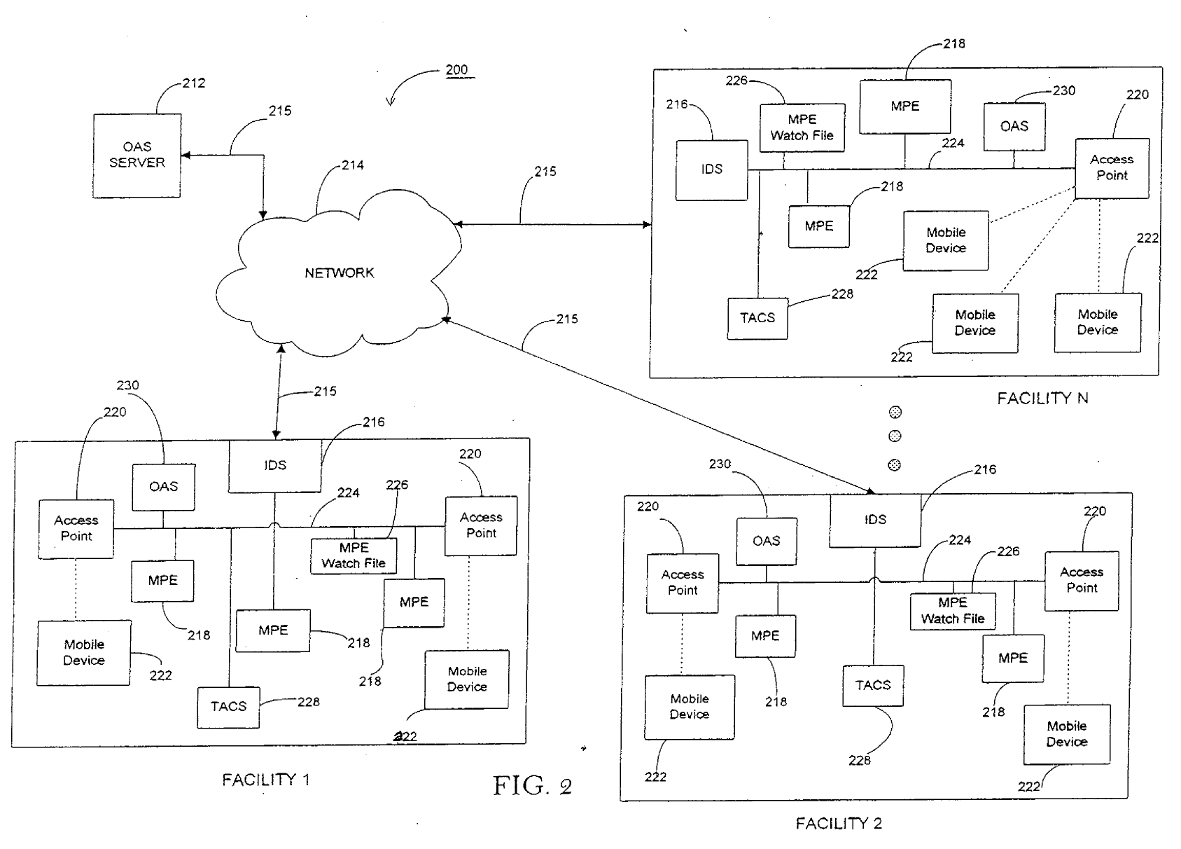

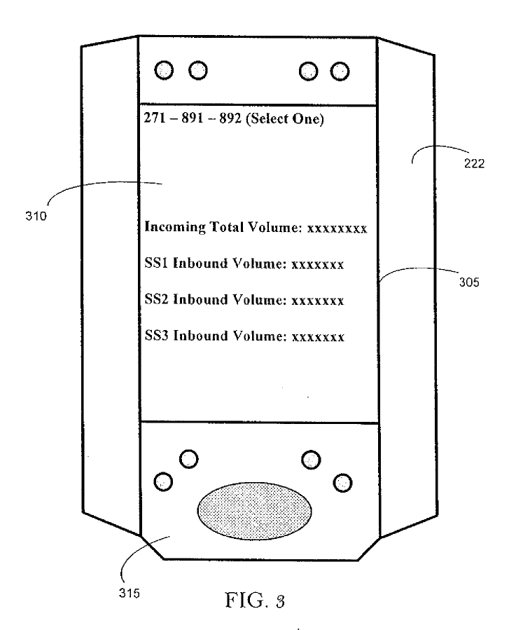

Because the supervisor of a processing facility is typically on the floor supervising operations, the operational information can be provided realtime or near real-time to a mobile device 112 carried by the supervisor. The mobile device 112 is in communication with the status system 114 via a wireless link. The mobile device 112 is a wireless communication device that includes a display. The mobile device 112 can be configured with a user interface capable of conveying operational information to the supervisor. In some embodiments, the mobile device 112 is, for example, a mobile phone, a cell phone, a PDA, a handheld computer, a laptop, or other suitable wireless mobile device that allows the receipt and display of operational information. Examples of user interfaces of a mobile device are illustrated in FIGS. 3-5 and described in reference to an exemplary embodiment as illustrated and described in reference to FIGS. 2-6.

Still referring to FIG. 1, each facility 104, 106, 108 also collects and stores processing facility data 114. Processing facility data 114 can include, for example, the status of sorting or other processing equipment (including, for example, the number of equipment failures, the operational state of the equipment, scheduled availability, maintenance data) and workforce (or employee) data (including, employee absences, operational tasking of each employee). Processing facility data can also comprise, or represent, data or metrics that are derived from any collected data relating to processing equipment and workforce data. For example, shipping data comprises the destination of where each item is being shipped. Processing facility data can also comprise the total number of people that are absent or the number of a certain type of machines that are inoperable, or other metrics derived from the individual employee or equipment data. In this way the processing facility data can be representative of one or more metrics related to the shipping facility workforce or the processing equipment.

The status system 114 can also be configured to send operational information relating to the processing facility data to the mobile device 112 to provide a current status of processing equipment and employees for which a supervisor is responsible. For example, the status system 114 can provide operational information relating to equipment failures to the mobile device 112 to alert a supervisor of equipment failure even if the supervisor is in another area of the facility, for example, on the loading dock overseeing a mail off-loading operation.

Additionally, the status system 114 can be configured to provide real-time information relating to the number of employees working on an individual operation in a particular processing facility. Such information can allow a supervisor to quickly transition resources to a key operational area to prevent back-ups from occurring during the processing of incoming items. The shipping data, equipment data, and workforce data collected by the status system 114 can include an enormous amount of data relating to numerous aspects of operating a processing facility. Based on operational desires, the status system 114 can be configured to use the shipping data, equipment data, and workforce data to generate consolidated operational information and provide the operational information that is determined to be immediately useful to the supervisor by displaying the information in a desired format on the mobile device 112.

### EXEMPLARY EMBODIMENT

FIG. 2 is a block diagram of a system 200 illustrating an example of one embodiment of a status system 114 described in reference to FIG. 1. The exemplary embodiment described in reference to FIG. 2 is a processing system for shipping items (e.g., mail, packages, parcels, and goods). However, system 200 is only one of many contemplated embodiments of a shipping and monitoring system that incorporates aspects of the invention. The description of system 200 is not meant to limit the invention to its applicability to a mail service, such as the U.S. Postal Service, or to a commercial mail and package service (e.g., FEDEX®, DHL®, or UPS®). Instead, the aspects described can be equally well implemented in many inter-facility and intra-facility shipping activities, including the U.S. Postal Service and commercial mail and package services.

One exemplary embodiment of a system 200 designed to collect data related to outgoing items from a number of associated processing facilities is illustrated in FIG. 2. The system 200 also provides operational information, that is related to processing items at a receiving facility, to a mobile device which can be carried by a supervisor at the receiving processing facility. Specifically, FIG. 2 illustrates a system 200 that, for a particular mail processing facility (e.g., Facility 1), can collect shipping data relating to the mail being shipped to Facility 1 from the other mail processing facilities (e.g., Facilities 2-N). System 200 also can collect processing facility data (e.g., status of sorting machines, transport devices, and other processing equipment and resources, and the status of the employee workforce of Facility 1) relevant to that particular facility. System 200 can constantly provide operational information, which is based on the shipping data and the processing facility data, to a mobile device of a supervisor of Facility 1 in real-time or near real-time. Using the operational information being provided on mobile device 222 by system 200, the supervisor can determine the best way to utilize his resources to meet operation requirements.

System 200 illustrated in FIG. 2 includes a inter-facility network 214 that allows data communication between Facilities 1, 2, . . . N. Connections 215 connect each of Facilities 1, 2, . . . , N to the network 214. The system 200 also includes intra-facility networks 224 that are configured for communication between the various systems located at each facility. The inter-facility network 214 and the intra-facility network 224 can include one or more wired or wireless networks, for example, one or more of the following networks: the Internet, intranets, local area networks (LAN), wide area networks (WAN), or other suitable networks. In addition, the connectivity to the network 102 may be, for example, remote modem, Ethernet, token ring, fiber distributed datalink interface (FDDI), asynchronous transfer mode (ATM), wireless Ethernet, or Bluetooth, or use another suitable communication connectivity.

The system 200 also includes a status system called an Operation Awareness System (“OAS”). The OAS includes an Operation Awareness System web server 212 (referred to hereinafter as the “OAS server 212”) connected to a communication network 214. The OAS also includes an OAS component 230 which is in communication with a number of other systems at each processing facility, and is typically located at each processing facility. The OAS collects data representative of activities at one or more facility from databases. In typical embodiments the database which stores the data for a processing facility is located at the facility. The OAS can communicate the portion of the collected data that is relevant to a particular processing facility to that facility. Data collected by the OAS includes processing facility data that is based on data generated at each facility. Typically, facility data is typically relevant only to the processing facility where it is collected. Accordingly, the OAS does not typically share facility data between processing facilities. However, in some instances facility data from one facility is provided to another facility, or facility data is provided to a user at another location, for example, to a manager concerned with operations in one or more processing facilities.

The OAS collects shipping data representative of outgoing items at each processing facility, and equipment and employee data representative of equipment activity and employee information at each facility. The shipping data collected at one facility that relates to activities at a second particular facility (e.g., number of incoming items) is communicated to the second facility and made available to a supervisor in the second facility in an easily interpretable and usable format. Equipment and employee data are facility specific, and therefore a supervisor (typically) wants to receive only the equipment data and employee data relating to his facility, but other facilities data can be provided as well. The actual data that is presented to a supervisor (e.g., operational data) can be determined and changed based on the supervisor's preferences and operational needs. Operational data is sent to the supervisor via a wireless transmission system, and presented to the supervisor via an easily interpretable display on a portable computer device.

The OAS server 212 includes at least a portion of the software for the Operation Awareness System and is configured to be in data communication with the inter-facility network 214. The OAS server 212 is configured to receive and send data to any of the connected mail processing facilities 1, 2, . . . N. Although the OAS server 212 is illustrated in FIG. 2 as geographically apart from any of the facilities 1, 2, N, in some embodiments it can be located at any one of the facilities 1, 2, . . . N. In some embodiments, the functionality of the OAS server 212 can be implemented in two or more servers that are in communication with each other. In such an embodiment, the two or more servers can be located together or located in different geographical locations (not shown), and can communicate over the inter-facility network 214 or another suitable network.

The system 200 also includes an OAS component 230 at each facility. The OAS component 230 may comprise a processor and a network interface for coupling the OAS component 230 to the inter-facility network 214. The OAS component 230 can comprise a dedicated computer system. In some embodiments, the functionality of the OAS components 230 is incorporated in an existing computer system at the processing facility. The OAS component 230 may also comprise a storage medium (not shown), e.g., a memory or a disk drive. The OAS component 230 may also comprise software modules that run on the processor to provide storage, control and communication functions to the system 200. For example, the software modules may include a database module configured to store data on a storage medium in a database. In some embodiments, the software modules include a communication module configured to send selected data to the OAS server 212 or another facility. An OAS component 230 typically located at each facility 1, 2, . . . N. The OAS component 230 is configured to communicate with the OAS server 212 via the inter-facility network 214, and to communicate with other systems at each facility via an intra-facility network 224.

Each processing Facility 1, 2, . . . N is in communication with the inter-facility network 214. During day-to-day operations, operational data is collected from data sources at each of the processing facilities. In this exemplary embodiment, the OAS collects data from three main data sources: an Integrated Data System, a Mail Processing Equipment (“MPE”) Watch File, and a Time, Attendance, and Compensation System. The Integrated Data System stores “shipping data” (e.g., data relating to piece count and destination of each item) from each processing facility. The OAS also collects “processing facility data” which includes data that is related to the specific equipment, operations, and/or employees at a specific processing facility or location. A portion of the processing facility data is stored in the Mail Processing Equipment (“MPE”) Watch File 226 that is located at each processing facility. The MPE watch file comprises equipment status data, data related to equipment failures or problems, and throughput volume of the equipment. The processing facility data further comprises workforce or employee data which is stored in a Time, Attendance, and Compensation System (“TACS”) 228. The workforce data includes, for example, the number of personnel working on any given mail flow operation, the number of hours worked on the mail flow operation, and the number of overtime hours worked on the mail flow operation. These three systems and files are described in further detail hereinbelow. While system 200 is described in reference to mail processing, other shipping organizations can be configured with similar data gathering systems, databases and files in which the invention can also be incorporated.

Integrated Data System

As stated above, the system 200 includes an Integrated Data System (“IDS”) which includes a plurality of IDS servers 216, at least one IDS server being in communication with each of the processing facilities 1, 2, . . . N. Typically, one IDS server is located at each of the processing facilities. Each of the JDS servers 216 are connected to the facility network 224 at their respective locations and communicate with the other systems through the facility network 224. Each of the IDS servers 216 is coupled to the inter-facility network 214 and configured to communicate with IDS servers 216 at other locations and with the OAS server 212 via the inter-facility network 214. The IDS 216 is the U.S. Postal Service's central source for the collection and distribution of mail processing and mail piece data from all automated mail processing equipment and material handling systems at the mail processing facilities. Currently there are approximately 290 IDS servers in the U.S. Postal System embodiment. In some embodiments there can be more IDS servers or fewer IDS servers, depending on for example, the number of different facilities.

Processing equipment scan and sort incoming items to determine shipping data based on the individual items. Shipping data includes the quantity and destination of outgoing mail that will be transported to one or more other mail processing facilities. This shipping data is automatically sent to the IDS servers 216 which collect and report the information at the end of each sorting run. As the items are being processed, the operation awareness system captures a copy of the shipping data from the IDS servers 216 and consolidates the shipping data on the OAS server 212. The OAS server 212 sorts and indexes the cumulative shipping data, and generates desired operational information for each processing facility. This information is sent to the OAS components 230 at the individual processing facilities that will be receiving the items. At each facility, operational information is processed by the OAS component 230, and made available for communication from an access point communication system 220 to one or more hand held mobile device 222 which is carried by a supervisor. The supervisors can automatically get incoming item volume updates on a periodic basis, for example, every five minutes, at another predetermined time interval, or when new data is available.

Processing Equipment

Each processing facility also includes one or more pieces of Mail Processing Equipment 218. “Mail Processing Equipment” is a broad term, which is used herein to refer to equipment that is located in a processing facility and that is related to processing items being shipped, including, for example, equipment used for processing the items coming into a facility, sorting and/or routing the items, and processing the items for transport outside the facility to another processing facility, or for delivery to the ultimate addressee.

Each MPE 218 is connected to the facility network 224 and configured to communicate with other components at the facility (e.g., an IDS server 216) through the facility network 224. During the operation of each MPE 218, data relating to its operational status is communicated to the Mail Processing Equipment Watch file 226 (“MPE Watch file”) over the facility network 224. The MPE Watch File 226 stores the operational status of each MPE 218, and is configured to be accessible to the OAS component 230 via the facility network 224. The data in the MPE Watch file 226 can include, for example, whether a piece of processing equipment is currently operating, whether a failure occurred and if so what type of failure (e.g., jam or mechanical breakdowns) the throughput of the equipment, the number of rejected, maintenance information related to the equipment, and any other information that can be sensed or determined relating to the operation of the processing equipment.

At a facility, the OAS component 230 is configured to query the MPE Watch file 226 to collect processing facility data relating to the equipment status. Operational information relating to the data collected and stored in the MPE Watch file 226 is generated by the OAS component 230 and sent to the mobile device 222 via an access point system 220. The operational information can then be displayed on a user interface of the mobile device 222. Although the OAS server 212 can be configured to access to the data in the MPE Watch File 226 (e.g., through the OAS component 230 of a particular processing facility) because the data in the MPE Watch File 226 is generally related only to that equipment at an individual facility, it is not typically communicated to the OAS server 212 or to other processing facilities.

Time, Attendance and Compensation System

Still referring to FIG. 2, information relating to the workforce of a processing facility is collected and stored in the Time, Attendance, and Compensation System (“TACS”) 228. TACS 228 is in data communication with the OAS component 230 via the facility network 224. TACS 228 is a system that tracks employees day-to-day attendance, absence, planned absences (e.g., vacation, travel) and current operational tasking. TACS 228 collects this information daily (or in accordance with another predetermined time period). At each facility, the OAS component 230 can access the workforce data stored in the TACS 228, and any desired operational information relating to the data in the TACS 228 can be generated and sent to the mobile device 222 and displayed. While the OAS server 212 can access workforce data stored in the TACS 228, the TACS data of a particular processing facility is generally related only to that particular facility. Accordingly, TACS data is not typically communicated to the OAS server 212 or to other processing facilities, but it can be if desired.

The OAS can periodically provide any operational information related to the data stored in the IDS 216, the TACS 228, or the MPE Watch file 226 to one or more mobile devices 222 at a particular processing facility 1, 2, . . . N. A shipping organization, such as the U.S. Postal Service, or other large shipping organization collects and stores an enormous amount of data in the IDS 216, the TACS 228, and the MPE Watch file 226, (or similar types of databases) which is collectively referred to herein as “operational data.” The operational data is consolidated and processed by the OAS so that only operational information relating to a specified (desired) portion of the entire set of operational data is sent to a supervisor's mobile device 222. The operational information may comprise portions of the shipping data or the processing facility data. Also, the operational information may comprise information derived from the shipping data or the processing facility data. For example, predetermined or dynamically determined metrics (e.g., service standards that specify the length of time it should take for items to be shipped from one location to another) may be applied to collected data to form the operational information communicated to a supervisor.

To communicate operational information to the mobile devices 222, each mail processing facility includes at least one access point system 220 that is configured to be in wireless communication with one or more of the mobile devices 222 used in the facility. At each facility, the access point system 220, the IDS 216, the MPES 218, and the OAS component 230 are in communication with each other via the facility network 224. A supervisor in the processing facility carries the mobile devices 228 while working away from their desks in and around the facility. The access point system 220 is configured to communicate timely operational information generated by the OAS component 230 to the mobile device 222, where the operational information is displayed for the supervisor's use to efficiently manage the facility's machine and human resources.

Although in some embodiments all processing facilities include the capability for using mobile devices 222, in other embodiments not all the processing facilities are configured to use mobile devices 222. However, even facilities that are not configured to provide operational information to supervisors over mobile devices 222 can include an IDS 216 that is configured to collect shipping data from all the Mail Processing Equipment 218 and provide shipping data to the OAS server 212 for use by other facilities.

The general configuration of each processing facility may be similar. However, more typically the operations and/or equipment of each processing facility is at least somewhat different than other facilities. For example, the amount of processing equipment (MPE) 218, access point systems 220, and mobile devices 222 at each facility can depend on such criteria as the number of items the facility processes, particular jobs that are performed at the facility, the number of supervisors requiring mobile devices, and other operational related criteria. In an exemplary embodiment, illustrated in FIG. 2, Facility 1 includes three MPEs 218 and two access point systems 220, where each access point system 220 is in wireless communication with one mobile device 222. Facility 2 is similarly configured as Facility 1 but includes only with two MPEs 218, Facility N includes two MPEs 218 and one access point system 220, which is in wireless communication with three mobile devices 222.

FIG. 3 is a diagram of a mobile device 222 that includes a display 305. A user interface screen 310 on the display 302 can present operational information. The mobile device 222 includes a control panel 315 that allows various information to be input into the mobile device 222, permitting a user to view desired data or send information to the access point system 220 and allowing two way communication between the supervisor and the OAS server 212. Based on operational needs, the mobile device 222 can be configured to display any of the data accessible to the OAS server 212, including shipping data from an individual facility or any other mail processing facility in communication with the OAS server 212, TACS 228, or the MPE Watch File 226. In some embodiments, the mobile device 222 is preconfigured to provide certain operational data. In some embodiments, the mobile device 222 can request specific data from the OAS server 212, or request that specific data from the OAS server 212 be provided on a periodic basis (e.g., every five minutes).

The mobile device 222 can be configured with a variety of user interface display screens to effectively display the desired operational data. In one example, the data collected from US Postal Service mail processing equipment includes the amount of mail destined for a ZIP code. The item volume for a particular ZIP code is collected from the sorting machines at each facility and sent to the Integrated Data System 216. The OAS consolidates this data from each separate processing facility, determines the total amount of mail destined for a particular ZIP code, and provides this operational data to the supervisor via the mobile device.

The OAS server 212 communicates with the IDS 216 at each processing facility to copy the mail piece data for all the outgoing mail processes (for example, including outgoing mail counts and destination data). The mail piece data for all the mail processing facilities is sent to the OAS server 212 where it is consolidated, and cumulative mail information is determined, and further processed according to established service standards. In this way, the time that mail should be arriving at the next processing facility may be determined. In other words, service standards are established for how long it should take an item, e.g., a piece of mail, to get from the origin (incoming) ZIP code to the destination ZIP Code, for example, 1, 2 or 3 days. OAS server 212 then sends cumulative incoming mail counts out to OAS components 230 at the appropriate districts and processing facilities. At each processing facility, the information is received from the OAS server 212 by the OAS component 230. The system is highly configurable to display whatever information is of importance to a supervisor. Desired information is communicated from the OAS component 230 to the access point system 220, and then communicated to the mobile unit 222 via a wireless link.

FIG. 3 also illustrates one example of a user interface 310 configured to show information relating to mail having certain operational codes, in this case outgoing primary and secondary mail pieces (Op codes 271, 891, and 892) on a display 305. As illustrated in FIG. 3, the mobile device 222 can be configured to receive and display a screen message every 5 minutes (or in some other desired increment) that indicates the current cumulative mail volume destined for the particular facility for that day (SS1 Inbound Volume), and the cumulative mail volume destined for the facility for the next day (SS2 Inbound Volume), the following day, and the day after that (SS3 Inbound Volume) for the different operational codes. In another example, an option on the user interface can be selectable to display the amount of mail for U.S. Postal Operational Codes 271 (DBCS/DIOSS OSS Outgoing Primary Mail), Operational Code 891 (DBCS/DIOSS BCS Outgoing Primary Mail), or Operational Code 892 (DBCS/DIOSS BCS Outgoing Secondary Mail).

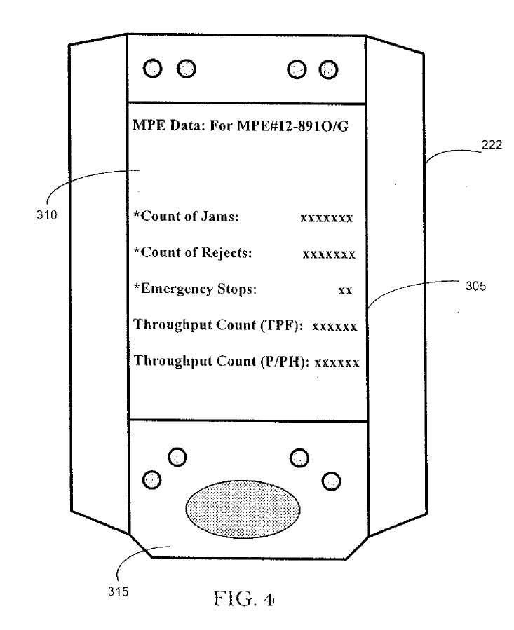

Both supervisors and maintenance personnel benefit from knowing the status of the mail processing equipment so they can assess its ability to handle the current and expected mail volume, and take immediate remedial action should a failure occur. FIG. 4 is a diagram of the mobile device 222 illustrating a user interface screen 310 for displaying the status of a particular piece of mail processing equipment. As described above, data for each piece of processing equipment is collected and stored in the MPE Watch file 226 at each facility. Operational information relating to the normal operations of the mail processing equipment, such as the throughput for each piece of equipment, can be provided to the mobile device 222 in accordance to a selected periodicity (e.g., every five minutes).

FIG. 4 shows one example of screen information a supervisor may receive for each piece of mail processing equipment, according to some embodiments. As illustrated in FIG. 4, the data displayed on the user interface screen 310 can include the identification of a particular piece of equipment (e.g., “MPE#12-891 O/G”) and operational information related to that equipment, including, for example, the “Count of Jams”, the “Count of Rejects”, the number of “Emergency Stops”, and various throughput counts including “Throughput Count (TPF)” and Throughput Count (P/PH). In some embodiments, the supervisor can scroll through the machine identifications to see operational information relating to each machine. For example, this information may indicate if jams are occurring, if there has been an emergency stop or if the count of rejects indicating the camera is not reading.

The Operation Awareness System can collect data from each piece of processing and sorting equipment. If data collected from a piece of equipment indicates a failure condition has occurred, or upon triggering of a predetermined condition (e.g., a critical threshold of the mail processing equipment), the OAS can alert a supervisor and/or maintenance technicians with an audio, visual, and/or mechanical (e.g., vibration) of the failure or condition. Information relating to the failure can also be supplied to identify which equipment failed and/or diagnose the reason for the alert.

In another aspect, operational information is provided by the OAS to the wireless device 222 to allow the supervisor to track how many employees are working on which operation, and for how long. This allows the supervisor to quickly shift employees to a different operation as situations change. In some embodiments, at a predetermined time period the OAS component 230 queries the Time, Attendance, and Compensation System data and captures the count of workers currently working on the specific operations. As employees change tasks or operations, the new operation codes are captured and the appropriate times are collected.

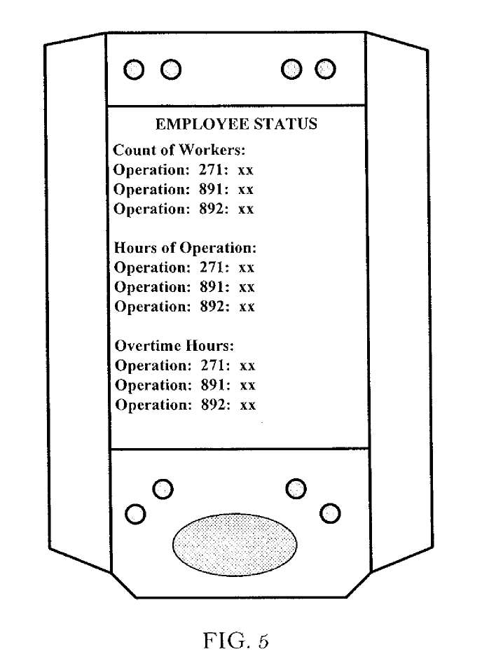

FIG. 5 is an example of a user interface screen 310 on the wireless device 222 displaying operational information relating to employee status. In particularly, the display specifically includes an illustration for displaying workforce information for three processing operations. In this example, the display shows the count of workers working on three different operations, the number of hours that each operation have been worked, and the overtime hours that have been worked on each operation. The user interface shown in FIG. 5 is only one of numerous display screens that can present employee data. In some embodiments, the user interface is configurable to display any other employee related data that is accessible by the operation awareness system.

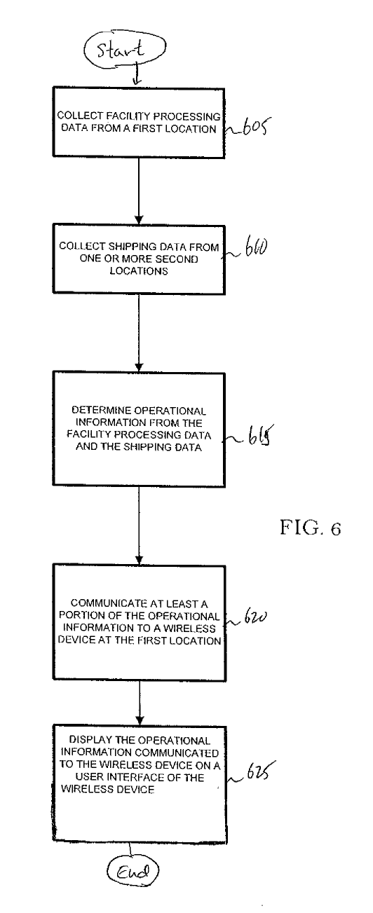

FIG. 6 is a flowchart illustrating a procedure 600 for providing information to process and ship items from one or more second locations to a first location. This process is terminated when its operations are completed. The process may correspond to a method, a function, a procedure, a software program, or part of a software program. The description of a process as a software program, module, component, subroutine, or a subprogram is a broad description and is not intended to require all embodiments to be implemented identically. Instead, one skilled in the art will recognize that such operations can typically be implemented in hardware, software, middleware, firmware, or microcode. Also, a process that is described as a single program or module may also be implemented in two or more modules, submodules, programs or subprograms or subroutines.

At state 605, process 600 collects facility processing data representative of activities at a first location. Typically, the facility processing data is collected from a database located at the first location. The facility processing data includes data related to the status of processing equipment and employee data at a first location. In state 610, process 600 collects shipping data representative of activities at one or more second locations. In one example, the shipping data is associated with items processed at the one or more second locations, that are being shipped to the first location. This data can include the quantity of items being shipped and destination information. In state 615, process 600 determines operational information from the facility processing data and the shipping data. The operational information relates to at least one aspect of the procedure for processing items received at the first location. In some embodiments, the operational information is determined using the shipping data and/or the processing facility data and other predetermined information such as service standards describing the duration of time it should take to ship an item from one location to another. In some embodiments, the operational information is essentially a portion of the shipping data or the processing facility data, but it may be placed in a different format for communicating to an OAS component 230 at a particular location, communicating to the mobile device 222, or for displaying in the user interface on the mobile device 222.

In state 620, the process 600 communicates at least a portion of the operational information to a wireless device. The operational data communicated to the wireless device can be based on any of the collected shipping data or processing facility data. In state 625, the process 600 displays on a user interface the operational information communicated to the wireless device for use by a supervisor to manage processing items received at the first location. The user interface can be configured to include numerous display screens for displaying the operational information. In some embodiments, the user interface is configurable by the supervisor so that it displays operational data in the format best suited to his individual preferences.

It is also noted that examples may be described as a process, which is depicted as a flowchart, a flow diagram, a structure diagram, or a block diagram. Although a flowchart may describe the operations as a sequential process, many of the operations can be performed in parallel or concurrently and the process can be repeated. In addition, the order of the operations may be re-arranged, operations not shown may be performed, or operations shown may be omitted depending on circumstances of an application of the process.

While the methods and system as described herein may be utilized, in one preferred embodiment, in the transportation and sorting of mail items by the U.S Postal System, the systems and methods may also be utilized for the effective monitoring and managing of other commercial package delivery companies such as UPS, FEDEX and DHL in order to meet stringent delivery deadlines.

Additionally, the systems and methods may also be utilized for the effective monitoring and managing of a large number of items shipped by other companies between processing (or manufacturing) centers where accurate and timely information of the workforce, processing equipment, and quantity of items for processing is required. The steps of a method or algorithm described in connection with the examples disclosed herein may be embodied directly in hardware, in a software module executed by a processor, or in a combination of the two. The various illustrative components and systems described in connection with the examples disclosed herein may be implemented, performed with, or embodied on a general purpose processor, one or more computers, one or more servers, or other suitable computing devices.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

1. A method of providing operational information in a first shipping facility at a first location, the first shipping facility receiving items from at least one second shipping facility which is at another location, the method comprising:
collecting facility processing data representative of a first plurality of metrics produced in association with the first shipping facility, wherein the first plurality of metrics includes information related to equipment resources and personnel resources;
collecting shipping data representative of a second plurality of metrics that include information related to items that are being shipped to the first shipping facility from the at least one second shipping facility;
determining operational information based on the facility processing data and the shipping data, wherein the operational information relates to the processing of items received at the first shipping facility from the at least one second shipping facility;
storing the operational information;
communicating at least a portion of the operational information to a wireless device at the first shipping facility; and
displaying the operational information communicated to the wireless device on a user interface of the wireless device.

2. The method of claim 1, wherein the shipping data comprises the number of items that are being shipped from the at least one second shipping facility to the first shipping facility.

3. The method of claim 2, wherein the items comprise mail.

4. The method of claim 1, wherein collecting facility processing data comprises collecting data from processing equipment that sorts the items being shipped.

5. The method of claim 1, wherein collecting facility processing data comprises collecting employee data.

6. The method of claim 1, wherein determining operational information from the shipping data comprises applying a predetermined factor to at least a portion of the shipping data.

7. The method of claim 6, wherein the predetermined factor comprises a service standard for shipping items from at least one of the second shipping facilities to the first shipping facility.

8. The method of claim 1, wherein collecting shipping data comprises receiving shipping data representative of the second plurality of metrics at the first shipping facility and the at least one second facility, the second plurality of metrics including the number of items to be shipped to other shipping facilities for a specified day.

9. The method of claim 8, wherein the specified day is the current day.

10. The method of claim 8, wherein determining operational information from the shipping data comprises using a service standard to generate an expected arrival date for items being shipped to the first shipping facility.

11. The method of claim 10, wherein displaying the operational information comprises displaying information representing the expected number of items incoming to the first shipping facility for a specified day.

12. The method of claim 10, wherein displaying operational information comprises displaying information representing the expected number of items incoming to the first shipping facility for a specified day.

13. The method of claim 1, wherein the operational information is periodically communicated to the wireless device in accordance with a user defined time period.

14. The method of claim 13, wherein the time period of communicating the operational information to the wireless device is less than five minutes.

15. The method of claim 1, wherein collecting facility processing data comprises collecting data from one or more pieces of processing equipment located at the first shipping location.

16. The method of claim 1, wherein displaying operational information comprises displaying at least one of following: equipment failures, equipment emergency stops, number of equipment jams, number of items rejected by the processing equipment, and throughput volume of the equipment.

17. The method of claim 1, wherein collecting facility processing data comprises collecting employee workforce data.

18. The method of claim 17, wherein the employee workforce data comprises at least one of the following: count of workers allocated to one or more operations, hours in operation for the one or more operations, and overtime hours for the one or more operations.

19. The method of claim 18, wherein displaying the operational information comprises displaying at least one of the count of workers allocated to one or more operations, hours in operation for the one or more operations, and overtime hours for the one or more operations.

20. The method of claim 1, wherein the user interface comprises one or more selectable display screens for displaying operational information.

21. A system configured to provide information in a first shipping facility at a first location, the first shipping facility receiving items from at least one second shipping facility which is in another location, comprising:
a data collection system configured to collect facility processing data representative of a first plurality of metrics associated with the first shipping facility, wherein the first plurality of metrics includes information related to equipment resources and personnel resources, the data collection system being further configured to collect shipping data representative of a second plurality of metrics associated with the at least one second shipping facility, wherein the second plurality of metrics includes information related to items that are being shipped to the first shipping facility from the at least one second shipping facility;
an operational information system configured to determine operational information based on the facility processing data and the shipping data collected by the data collection system, wherein the operational information relates to processing items received at the first shipping facility from the one or more second shipping facilities, and whereas the operational information is further configured to provide operational information to the first shipping facility;
a communication system located at the first shipping facility for receiving operational information, and further configured to communicate at least a portion of the operational information to a wireless device; and
a wireless device configured to receive the operational information from the operational information system, wherein the wireless device comprises a display, and wherein the wireless device further comprises a user interface configured to control the display of the operational information.

22. The system of claim 21, wherein the user interface comprises a display screen to display an expected cumulative incoming item volume for the current day and at least one day subsequent to the current day at the first location.

23. The system of claim 21, wherein the user interface comprises a display screen to display an expected cumulative incoming item volume for the current day and three days subsequent to the current day.

24. The system of claim 21, wherein the operational information is periodically communicated to the wireless device.

25. The system of claim 24, wherein the period of communicating the operational information to the wireless device is a user selectable parameter.

26. The system of claim 21, wherein the user interface comprises a display screen to display status information of one or more pieces of processing equipment at the first shipping facility.

27. The system of claim 26, wherein the status information comprises at least one of following: equipment failures, equipment emergency stops, number of equipment jams, number of items rejected by the processing equipment, and throughput volume of the equipment.

28. The system of claim 21, wherein the operational information system is configured to receive a request for operational information from the wireless device and to provide operational information to the wireless device based on the request, and wherein the user interface is configured to receive as input a request for operational information, and wherein the wireless device is configured to communicate the request for operational information to the operational information system.

29. The system of claim 21, wherein said user interface comprises a display screen to display employee information.

30. The system of claim 29, wherein said employee information comprises the number of workers on one or more pre-determined mail processing operations, the hours in operation of said one or more pre-determined mail processing operations, and the overtime hours worked on said one or more pre-determined mail processing operations.

31. A system configured to provide information in a first shipping facility at a first location, the first shipping facility receiving items from at least one second shipping facility at another location, comprising:
means for collecting facility processing data representative of a first plurality of metrics produced in association with the first shipping facility, wherein the first plurality of metrics includes information related to equipment resources and personnel resources;
means for collecting shipping data representative of a second plurality of metrics that include information related to items that are being shipped to the first shipping facility from the at least one second shipping facility;
means for determining operational information based on the facility processing data and the shipping data, wherein the operational information relates to the processing of items received at the first shipping facility from the at least one second shipping facility;
means for storing the operational information;
means for communicating at least a portion of the operational information to a wireless device at the first shipping facility; and
means for displaying the operational information communicated to the wireless device on a user interface of the wireless device.

32. A machine readable medium comprising instructions for providing operational information in a first shipping facility at a first location which receives items from at least one second shipping facility at a second location to manage an operation at the first location, that upon execution cause a machine to:
collect facility processing data representative of a first plurality of metrics produced in association with the first shipping facility, wherein the first plurality of metrics includes information related to equipment resources and personnel resources;
collect shipping data representative of a second plurality of metrics that include information related to items that are being shipped to the first shipping facility from the at least one second shipping facility;
determine operational information based on the facility processing data and the shipping data, wherein the operational information relates to the processing of items received at the first shipping facility from the at least one second shipping facility;
store the operational information;
communicate at least a portion of the operational information to a wireless device at the first shipping facility; and
display the operational information communicated to the wireless device on a user interface of the wireless device.
